(19) United States
(12) Patent Application Publication
(10) Pub. No.: US 2022/0358356 A1
(43) Pub. Date: Nov. 10, 2022

(54) COMPUTERIZED METHODS OF FORECASTING A TIMESERIES USING ENCODER-DECODER RECURRENT NEURAL NETWORKS AUGMENTED WITH AN EXTERNAL MEMORY BANK

(71) Applicant: INTERNATIONAL BUSINESS MACHINES CORPORATION, ARMONK, NY (US)

(72) Inventors: Mircea R. Gusat, Langnau am Albis (CH); Konstantinos Kouziou, Patras (GR); Charalampos Pozidis, Thalwil (CH)

(21) Appl. No.: 17/301,990

(22) Filed: Apr. 21, 2021

(51) Int. Cl. G06N 3/08; G06N 3/04

(52) U.S. Cl. CPC G06N 3/08; G06N 3/0454; G06N 3/0445

(57) ABSTRACT

A computer-implemented method forecasts a timeseries. The method includes loading and running a machine learning model. The machine learning model includes an encoder recurrent neural network (RNN) mapping an input sequence into a fixed-dimensionality vector c and a decoder RNN decoding the vector to produce an intermediate sequence. The model includes a fully connected feed-forward layer (FC-FFL) to produce an output sequence. The machine learning model is run concomitantly. Values of a given input sequence are coupled to produce a given output sequence in output of the FC-FFL. Values of a feedback sequence are stored in a location-addressable memory bank. The memory addresses of the memory bank are mapped onto a temporal sequence of the feedback sequence. Values stored are read to retrieve values of the feedback sequence. The retrieved values are fed to the decoder RNN as the model is being run to obtain the given output sequence.

### STATEMENT REGARDING PRIOR DISCLOSURES

The document “Skipper: A Forecasting Model for Non-stationary Multivariate Time-series”, Swiss federal Institute of technology Zurich, Master Thesis, was authored by Konstantinos Kouziou and published on Jun. 8, 2020. This document, hereafter referred to as “Kouziou 2020”, was prepared under advisement of Mircea R. Gusat (also known as Mitch Gusat), himself managed by Charalampos Pozidis (also known as Haris Pozidis). Konstantinos Kouziou, Mitch Gusat, and Charalampos Pozidis, have invented the subject matter of the present patent application document. Contents of the document Kouziou 2020 are incorporated by reference to the maximum extent allowable by law.

### BACKGROUND

The invention relates in general to the field of computerized techniques for forecasting timeseries. In particular, it is directed to computer-implemented methods relying on a machine learning (ML) model involving recurrent neural networks (RNNs) in an encoder-decoder configuration (e.g., also known as sequence-to-sequence architecture), where the ML model is connected to a location-addressable memory bank to overcome memory limits of the cells of the RNNs. This, in turn, makes it possible to suitably process long timeseries (e.g., possibly having seasonality), to learn long temporal patterns. The invention is further directed to methods of anomaly detection using a method as evoked above, as well as computer program products designed to perform such methods.

Various models are known, which can process sequences of data and make predictions of the future based on past data. Models such as the so-called Box-Jerkins models are not adequate for modern multivariate environments. Being primarily developed to process univariate sequences, such models cannot assist predictions by learning spatial cross-correlations between the different variables. RNNs do not suffer from this limitation. They are a class of deep learning (DL) architectures that can adequately process sequential data; they have notably demonstrated excellent performance in tasks including speech and handwriting recognition, machine translation, and timeseries forecasting.

Despite such successes, RNNs fail to satisfactorily learn long temporal patterns. Even their more sophisticated variants, e.g., involving long-short term memory (LSTM) and gated recurrent unit (GRU) cells, will fail or take too long to learn dynamics spanning over a few hundred instances. This is insufficient for many applications. Indeed, many real-world timeseries contain long temporal patterns that even sophisticated RNNs struggle to learn. In particular, applications to weather forecasting require a model with a sufficiently high resolution, because the weather can abruptly change (e.g., almost instantaneously). For instance, assuming a sampling time of 1 hour, both the GRU and LSTM cells will only remember information they observed during the past few weeks. Therefore, year-long dynamics of the weather cannot be taken into account for prediction purposes.

Accordingly, there is a need for improved techniques of forecasting timeseries.

### SUMMARY

According to a first aspect, the present invention is embodied as a computer-implemented method of forecasting a timeseries. The method comprises loading and running a machine learning (ML) model. The ML model includes two recurrent neural networks (RNNs), including an encoder RNN coupled to a decoder RNN. The model is designed to allow the encoder RNN to map an input sequence X into a fixed-dimensionality vector c. Furthermore, the model is designed to allow the decoder RNN to decode such a vector c to produce an intermediate sequence H. The model further includes a fully connected feed-forward layer (noted FC-FFL). The FC-FFL is coupled to the decoder RNN to be able to produce, from the intermediate sequence H, an output sequence Y having a dimensionality that is decoupled from a dimensionality of the intermediate sequence H. The ML model is run by concomitantly performing the following steps. To start with, values of a given input sequence (forming a timeseries) are coupled into the encoder RNN to produce a given output sequence in output of the FC-FFL. Eventually, a forecast timeseries is obtained based on this given output sequence. In addition, values of a feedback sequence are stored in a location-addressable memory bank. The latter is connected to the loaded model. The feedback sequence is one of the given input sequence and the given output sequence. The memory addresses of the memory bank are mapped onto a temporal sequence of the feedback sequence, whereby time-shifted values of the feedback sequence are stored at respective memory addresses of the memory bank. Moreover, values stored in the memory bank are read by the memory addresses to retrieve values of the feedback sequence. The retrieved values are fed to the decoder RNN as the model is being run, in view of obtaining the given output sequence in output of the FC-FFL.

In preferred embodiments, the feedback sequence is the given input sequence. The retrieved values are injected in respective cells of the decoder RNN, so as to achieve temporal skip connections between cells of the decoder RNN.

According to another aspect, the invention is embodied as a computer-implemented method of detecting an anomaly in a computerized system. This method first comprises accessing a timeseries of one or more measured values of quantities pertaining to the operation of the computerized system. Next, based on the accessed timeseries, a forecast timeseries is obtained by performing a method of forecasting a timeseries as described above, where said given input sequence corresponds to the accessed timeseries. A prediction error of the forecast timeseries obtained is subsequently characterized. Eventually, an anomaly score is determined based on the characterized prediction error to potentially detect an anomaly in the computerized system. The prediction error can for instance be characterized by comparing a predicted timeseries with an actual timeseries, as obtained for the same time period. Such a method can be performed to monitor the computerized system for anomalies in real time.

According to a final aspect, the invention is embodied as a computer program product for forecasting a timeseries. The computer program product comprises a computer readable storage medium having program instructions embodied therewith. The program instructions are executable by processing means, so as to cause the processing means to perform a method such as described above.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIGS. 1A and 1B are diagrams illustrating a recurrent neural network (RNN) cell in its recurrent form (FIG. 1A) and unfolded in time (FIG. 1B). Such an RNN cell may produce one output for every instance of an input timeseries, as involved in embodiments;

FIG. 2 is a diagram of an RNN with temporal skip connections between the cell states, as also involved in embodiments;

FIG. 3 is a diagram depicting a sequence-to-sequence architecture with unfolded RNNs, whereby an encoder RNN is connected to a decoder RNN, as in embodiments;

FIG. 4 is a diagram illustrating a baseline architecture as used in embodiments. Each output of the sequence-to-sequence model of FIG. 3 is further processed by a time-independent, feed-forward layer f that decouples the number of RNN units from the number of output features, as in embodiments;

FIG. 5 is a diagram illustrating an initial approach tested by the present inventors to incorporate an arbitrarily long seasonal feedback into a sequence-to-sequence model by augmenting both the encoder RNN and the decoder RNN with a memory bank. The r and w vectors represent read and write operations from and to the memory bank, respectively. However, this model, also referred to as “Skipper v0” in the following description, has several downsides (notably in terms of training); this model is not according to the invention;

FIG. 6 is another diagram, which illustrates another approach (referred to as “Skipper v0.1” in the following description). In this approach, values of the output timeseries are stored in the memory bank (the decoder memory in FIG. 6). This model addresses training challenges of the model of FIG. 5 by retrieving a skip state from past predictions, as in embodiments;

FIG. 7A is a further diagram illustrating a particularly preferred model (“Skipper v1.0”), in which values of the input timeseries are stored in the memory bank. The bank is then accessed by the decoder RNN to retrieve instances from a previous season, which instances can then adequately be correlated with current predictions, according to in embodiments;

FIG. 7B depicts an external memory bank as a matrix, wherein each column corresponds to a respective time step and each row corresponds to a respective feature of an input sequence (e.g., a timeseries). The values stored in the memory bank are read using a mask designed to select distinct row elements of the rows of the matrix; the row elements are selected according to the (distinct) season lengths of the timeseries features, according to embodiments. This allows each feature of the timeseries to have a different skip length;

FIG. 8 shows a diagram illustrating a variant (“Skipper v1.1”) to FIG. 7A, where a spatial highway connects the seasonal feedback directly to the outputs, as in embodiments;

FIG. 9 is a further diagram illustrating another variant (“Skipper v1.2”) to FIG. 7A, in which additional components allow the timeseries to be decomposed into seasonal and trend dynamics, according to embodiments;

FIGS. 10A and 10B show timeseries of given key performance indicators (KPIs) of a monitored computerized system. Such timeseries can typically be used to form input sequences to be processed by models as depicted in FIGS. 3-9. FIG. 10A shows a KPI evolving over a single season. This KPI has a large anomaly at time step≈13,500. This anomaly decays to finally vanish at time step≈17,500. FIG. 10B depicts a KPI over 2016 time steps (corresponding to approximately seven seasons). The season length can notably be determined by computing the autocorrelation function, as in embodiments;

FIG. 11 is a flowchart illustrating high-level steps of an anomaly detection method according to embodiments, the core operations of which involve a model such as shown in FIGS. 6-9;

FIG. 12 schematically represents a general-purpose computerized system, suited for implementing method steps as involved in embodiments of the invention;

FIG. 13 depicts a cloud computing environment as involved in embodiments of the invention; and

FIG. 14 depicts abstraction model layers as involved in embodiments of the invention.

The accompanying drawings show simplified representations of devices or parts thereof, as involved in embodiments. Similar or functionally similar elements in the figures have been allocated the same numeral references, unless otherwise indicated.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

Computerized methods and computer program products embodying the present invention will now be described, by way of non-limiting examples.

### DETAILED DESCRIPTION OF EMBODIMENTS OF THE INVENTION

The following description is structured as follows. General embodiments and high-level variants are described in section 1. Section 2 addresses more specific embodiments as well as background techniques. Section 3 discusses technical implementation details.

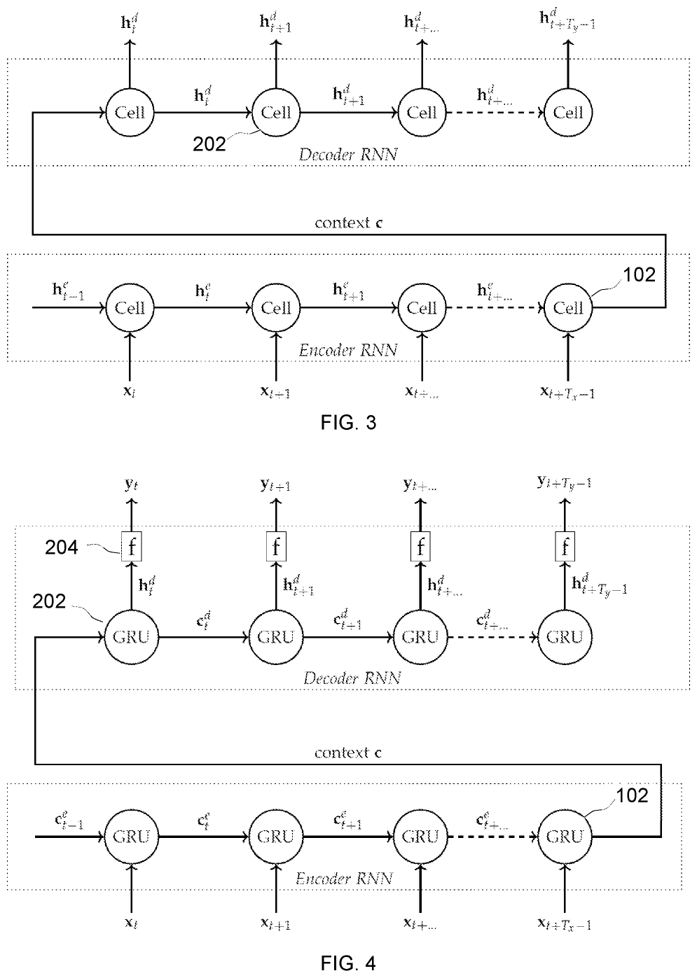

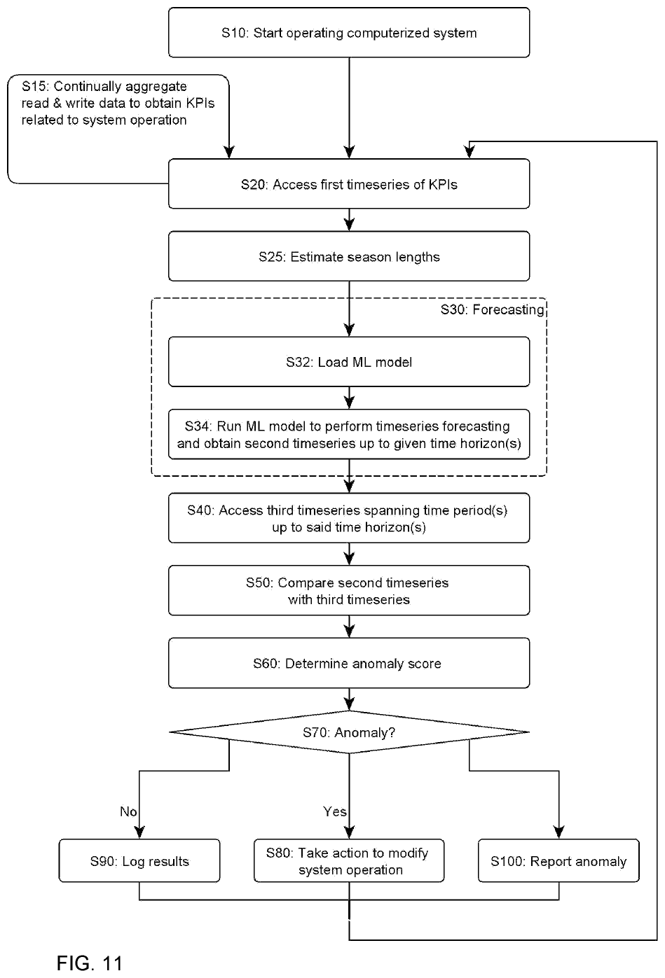

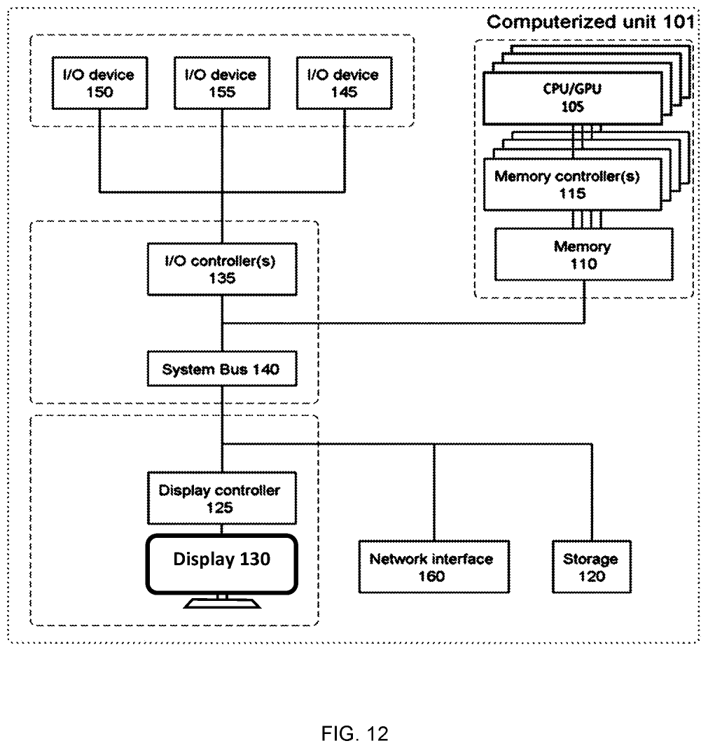

All references Sn refer to methods steps of the flowchart of FIG. 11, while numeral references pertain to parts or components of a computerized system such as shown in FIG. 12 or to components of the machine learning models shown in FIGS. 3-9.

### 1. General Embodiments and High-Level Variants

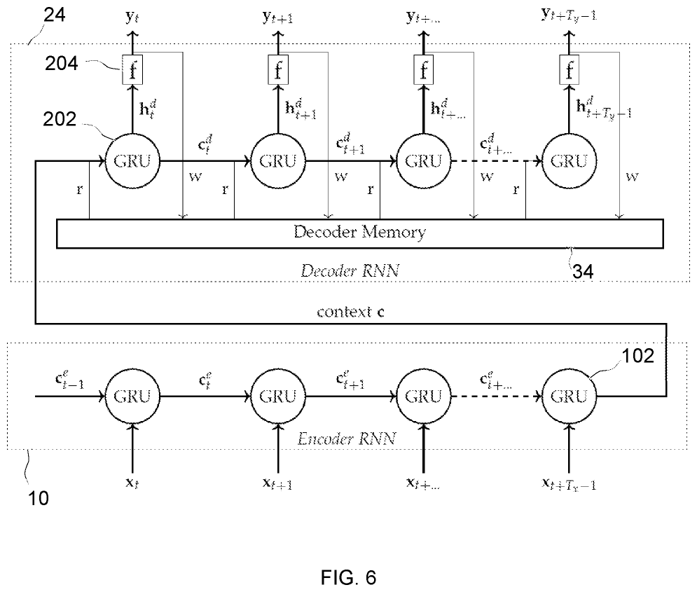

In reference to FIGS. 6-9, and 11, a first aspect of the invention is now described, which concerns a computer-implemented method of forecasting S30 a timeseries. Some terminologies are first defined.

To start with, a “feature” relates to one or more quantities or variables, e.g., key performance indicators (KPIs) observed over several time steps. A “datapoint” refers to the value of one or more of the features involved at a given time step.

A timeseries aggregates one or more features as a series of data ordered by the time the data are collected or produced. Such data is usually spaced at equal intervals. A univariate timeseries pertain to a single feature, which, however, may be an array of any dimension (e.g., a vector), while a multivariate timeseries pertain to multiple features. Timeseries are commonly specified by time-value pairs. E.g., a univariate timeseries can be of the form {tᵢ, vᵢ}, where the values vᵢ are normally scalars, although the values vᵢ may also represent vector components of a given variable (e.g., a vector). Yet, the values vᵢ typically all have the same dimensionality. The time values tᵢ may possibly be omitted in the timeseries (they can be implicit). So, values corresponding to a particular feature v form a sequence {v₁, v₂, . . . , vₘ}, hereafter abbreviated as {v_{i:m}}. A multivariate timeseries can be in the form {{t₁, u₁, v₁, . . . },{t₂, u₂, v₂, . . . }, . . . }, where the values uᵢ, vᵢ, . . . pertain to respective features or quantities. An “instance” corresponds to a particular time step (e.g., a particular point in time corresponding to a given element {uᵢ, vᵢ, . . . }). So, an instance from a previous season refers to an event observed in that previous season and may correspond to a similar or same event observed in another (e.g., current) season.

The present method relies on a machine learning (ML) model, which involves two recurrent neural networks (RNNs) and a fully connected, feed-forward layer (FC-FFL). The two RNNs include an encoder RNN 10 coupled to a decoder RNN 24, 25, 26, 27, see FIGS. 6-9. The basic architecture (FIG. 3) can be regarded as a sequence-to-sequence architecture (also known as an encoder-decoder architecture). However, more sophisticated architectures can be contemplated, as discussed later in detail.

The model is generally designed to allow the encoder RNN 10 to map an input sequence X into a fixed-dimensionality vector c. The model is further designed to allow the decoder RNN to decode such a vector c to produce an intermediate sequence H.

Compared to a sequence-to-sequence architecture such as shown in FIG. 3, the present method augments the RNNs with a FC-FFL 204, denoted by f in the accompanying drawings. The FC-FFL 204 is coupled to the decoder RNN 24-27. The resulting baseline is depicted in FIG. 4. The FC-FFL 204 is designed so as to be able to produce an output sequence Y, where the latter has a dimensionality that is decoupled (e.g., distinct) from the dimensionality of the intermediate sequence H that it takes as input. In other words, the dimension of the output sequence Y need not be the same as the dimension of the intermediate sequence H. Note, dimensionality here refers to the number of features. The use of the FC-FFL 204 allows a more flexible model to be obtained (by the additional hyperparameters), which has a larger capacity, making it able to learn more complex timeseries. E.g., the dimension of H can be as large as needed, while it is still possible to work on specifically dimensioned outputs. This makes it possible to learn any number of outcomes, irrespective of the actual dimension of H.

Besides, it is possible to tune the time horizon of the forecast timeseries. Moreover, the size of the history may advantageously be much larger than that of the horizon used to forecast timeseries, because X and Y can have different lengths.

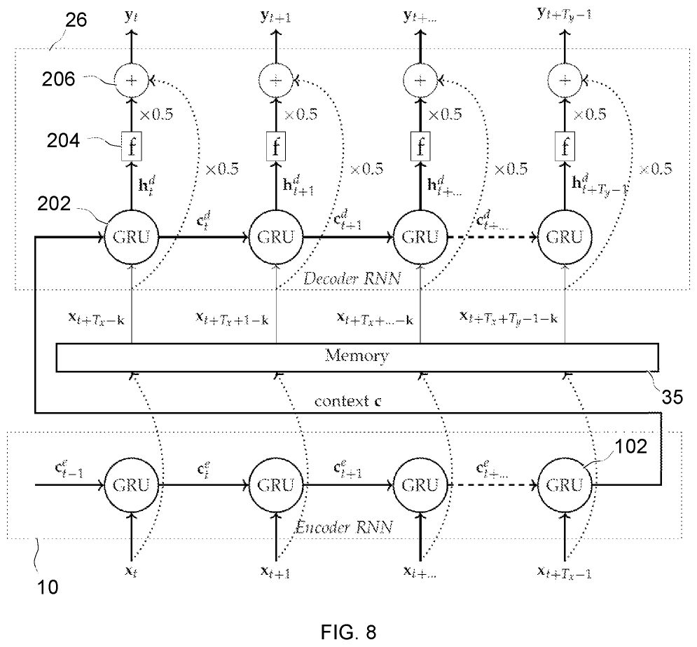

As shown in the flow of FIG. 11, the model is loaded at step S32 and run at step S34. Running the model comprises concomitantly performing a series of steps, which are illustrated in FIGS. 6-9. Such steps notably include coupling values of a given input sequence (forming a timeseries) into the encoder RNN 10. This produces a given output sequence in output of the FC-FFL. Eventually, a forecast timeseries is obtained based on this given output sequence; the forecast timeseries may possibly be identical to the output sequence (as assumed in FIGS. 6, 7A, and 9), or not (as related to FIG. 8). All the timeseries involved are preferably non-stationary, multivariate timeseries, possibly having some degree of seasonality. However, the present methods may also be implemented with univariate timeseries.

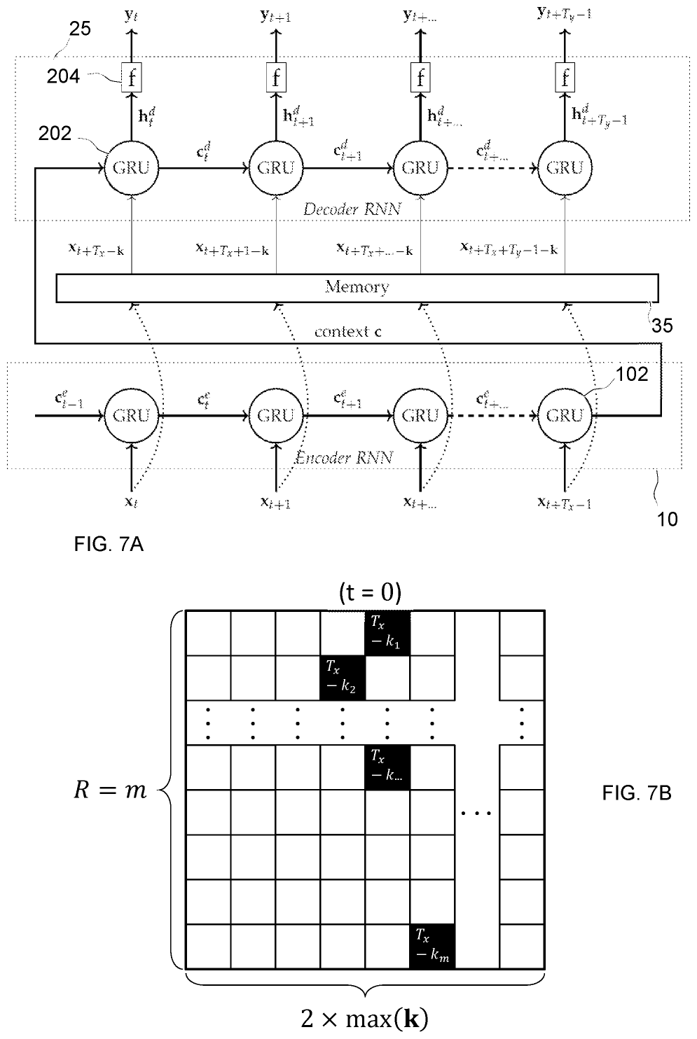

Meanwhile, a feedback mechanism is enabled by storing values of a sequence (hereafter termed “feedback sequence”) in a location-addressable memory bank 34, 35. The latter is an external memory (e.g., a memory added to the baseline model of FIG. 4). That is, the values stored in the memory bank are meant to be used as feedback, for the model to be able to suitably correlate current observations with the feedback values. In practice, the feedback sequence corresponds either to the given output sequence (as assumed in FIG. 6) or the given input sequence (as assumed in FIGS. 7-9). Preferred is to use the input sequence, for reasons that will become apparent later.

The memory bank 34, 35 is connected to the loaded ML model (e.g., the memory bank is in data communication with the loaded model, whereby data is exchanged between the model (as the latter is being run) and the memory bank). The memory addresses of the memory bank 34, 35 are mapped onto the temporal sequence of the feedback sequence. As a result, time-shifted values of the feedback sequence are stored at respective memory addresses of the memory bank.

The values stored in the memory bank 34, 35 are read by the memory addresses. This makes it possible to deterministically retrieve values of the feedback sequence and feed the retrieved values to the decoder RNN 24-27, in view of obtaining the given output sequence and, eventually, the forecast timeseries.

Comments are in order. As said, the three steps described above (e.g., coupling input values, storing and reading the feedback values) are concomitantly performed. Moreover, such steps are interdependent. More precisely, the input values coupled into the encoder RNN impact the output sequence formed in output of the FC-FFL, as per the operation of the encoder-decoder RNNs. The retrieved values (feedback values) impact the output sequence obtained as well, since values of the feedback sequence are fed to the decoder RNN. Typically, feedback values are stored in the memory bank, while coupling input values into the encoder RNN. Meanwhile, feedback values are read from the memory bank, for the model to produce output values, from which forecast timeseries can be obtained.

The memory bank is location-addressable, as opposed to a content-addressable memory. So, values corresponding to each time step are stored in a respective location in the memory. Yet, where multivariate timeseries are involved, several values may possibly be stored at that same location; said several values then correspond to several features. In that respect, the memory bank can normally be represented as a matrix, as in embodiments discussed below in reference to FIG. 7B. The location-based addressability of the memory can be exploited to store arbitrarily long or/and variable feature seasonalities, as in embodiments discussed later in detail.

The above ML model can be run for both training and inference purposes, although the training phase normally involves additional steps for the model to learn its own parameters. The model can notably be trained online, in a permanent (e.g., ongoing) fashion. Therefore, the above method can be implemented for both training and inference purposes. In the following, however, this method is assumed to be performed for inference purposes (e.g., forecasting), for simplicity.

Eventually, a forecast timeseries is obtained based on the output sequence as obtained in output of the FC-FFL. As noted earlier, the forecast timeseries may possibly be identical to said given output sequence, as in FIGS. 6, 7A, and 9. In FIG. 8, the output sequence is mixed with values retrieved from the memory banks, for reasons explained later.

In all cases, the feedback sequence allows correlations to be adequately detected by the decoder RNN 24-27, even when long sequences (e.g., corresponding to long seasons) are involved. This is made possible by an adequately addressed memory bank 34, 35. As said, the memory addresses of the memory bank are mapped onto the temporal sequence of the feedback sequence. That is, the memory addresses are mapped according to time steps of the feedback sequence. The temporal gaps between successive time points of the feedback sequence correspond to temporal gaps of the output sequence and the forecast timeseries too. In other words, each address gap corresponds to the temporal gaps in the feedback sequence, such that every value stored in the memory bank can be deterministically retrieved. This can notably be exploited to correlate currently observed values with previous values of the timeseries, even when the previous values pertain to a distant past.

Note, the memory addresses normally correspond to logical addresses in the present context. This, however, is unimportant. Such addresses may also be physical addresses or surrogate addresses. What matters is that such addresses allow memory locations to be precisely determined.

The memory bank may contain all relevant states or, more generally, all relevant values, e.g., values for every instance of one or more previous seasons. Temporal skips can thus be implemented by dynamically reading variable states from the memory bank instead of a fixed (e.g., static) skip vector. The proposed method can accordingly be used to improve upon a sequence-to-sequence baseline such as shown in FIG. 4, notably for forecasting timeseries with long and/or variable seasons.

The addressing scheme used for the memory databank provides a tractable way of exploiting the additional memory bank and thereby surpass the memory limits of the cells of the RNNs (e.g., it provides a practical way to read from and write to an external memory bank). Notwithstanding, the ML model used remains time-agnostic and does not need to know the time values it operates on.

Note, an attention mechanism may possibly be implemented between the encoder RNN and the decoder RNN in the present context. Such an attention mechanism may use contents read from the memory bank. Thus, one understands that the present methods does not necessarily require a strict sequence-to-sequence architecture.

Embodiments of the above method can notably be used to predict unprocessed (real-world) data collected in the wild from computerized systems (e.g., computers, cloud storage devices). The proposed approach was found to be robust even under significant seasonality breaks caused by data anomalies. It outperforms the baseline of FIG. 4 both in terms of convergence rate and prediction error. The proposed method can further be employed as part of an anomaly detection (AD) engine, where the seasonal feedback brings new insights into events that are normal but infrequent, as discussed later in reference to another aspect of the invention.

To the best of the knowledge of the present inventors, the ML models discussed herein are the first class of explainable memory augmented ML models that make it possible to learn arbitrarily long and/or changing seasonal dynamics that surpass the memory limits of the RNN cells. Note, the most general model proposed herein can be said to be explainable inasmuch as the difference between the proposed model and the baseline revolves around the feedback sequence (e.g., any improvement observed with respect to the baseline can only be the result of taking the feedback sequence into account).

In the following, four classes of embodiments are discussed in detail, which correspond to four classes of ML models, respectively. The corresponding models are referred to as “Skipper v0.1”, “Skipper v1.0”, “Skipper v1.1”, and “Skipper v1.2” in this document, like in Kouziou 2020. That is, four versions (v0.1, v1.0, v1.1, and v1.2) of the same general model can be distinguished, as illustrated in FIGS. 6-9, respectively. A few variants to such models are occasionally evoked in this document. However, it will be apparent to the one skilled in the art that many more variants can be contemplated.

All this is now described in detail, in reference to particular embodiments of the invention. To start with, the feedback sequence is preferably the input sequence, as assumed in FIGS. 7A, 8, and 9. The values retrieved from the memory bank are injected in respective cells of the decoder RNN 24-27. This can advantageously be done so as to achieve temporal skip connections between the cells of the decoder RNN 24-27, as assumed in the versions 1.0, 1.1, and 1.2 of the ML model, respectively corresponding to FIGS. 7A, 8, and 9. This approach was generally found to be the most robust approach.

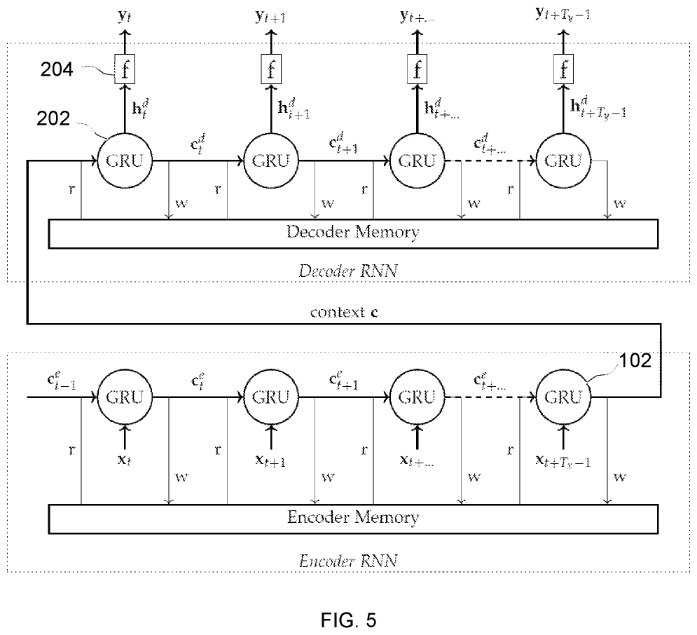

In variants, the feedback sequence corresponds to the output sequence. That is, values of the output sequence may be stored in and retrieved from the memory bank 34, as in version v0.1 of the model, see FIG. 6. Another approach may be to store and retrieve states of the decoder RNN cells, as in the version v0 of the model, FIG. 5. Such an approach, however, has shown severe drawbacks and is not according to the invention. All such approaches are discussed in detail in section 2.

Preferably, the cells of the encoder RNN 10 and the decoder RNN 24-27 are gated recurrent units (GRUs) 102, 202, as assumed in FIGS. 6-9. In variants, the RNNs may be based on long-short term memory (LSTM) cells, which lead to similar results. However, the smaller number of gates of the GRU cells implies less training parameters. As a result, the resulting RNNs converge faster and are computationally more tractable.

In embodiments, the method further comprises estimating S25 the season length(s) of the features of the input sequence. Step S25 is performed offline (e.g., prior to running the ML model at step S34). In turn, the estimated season length(s) can be utilized to read values stored in the memory bank and thereby retrieve feedback values that pertain to one or more previous seasons (e.g., seasons preceding the season corresponding to the current observations).

Several season lengths may need be computed, should the input sequence involve several features that have distinct seasonalities. Notwithstanding, the memory bank can be accessed by the decoder RNN cells to retrieve instances from the previous seasons, taking the distinct season lengths into account. This way, the retrieved instances may adequately be correlated with current predictions, as in version v1.0 of the model, FIG. 7A. That is, for each instance, the temporal skip connections bring forward values (states) from the equivalent instance of the previous season, notwithstanding the distinct season lengths involved. Thus, a seasonal feedback can be achieved, even for long seasons that exceed the memory allowed by the RNN cells, and even if the various features involved have different season lengths.

The season lengths are preferably estimated (step S25) by computing autocorrelation functions (ACFs) of the corresponding timeseries features. The ACF peaks when the timeseries values are in phase with themselves, which happens once every season. So, the ACF makes it very easy and practical to estimate the season lengths. In variants, one may also use Fourier transforms or wavelet transforms, for example. Computations based on the Fourier transform yield mathematically identical results but require additional operations in the present context. Wavelet transforms often lead to more accurate results than ACFs, also being more informative about events that occurred. However, relying on the ACF is simpler in practice.

The memory bank may advantageously have a certain memory depth R, where this depth is larger than or equal to the number m of timeseries features, the latter corresponding to the number of observed variables. The same memory depth R is available at each memory address and, therefore, applies to every time instance of the feedback sequence. That is, the memory depth R at each memory location (corresponding to a respective memory addresses) is larger than or equal to the number m of timeseries features. This way, all relevant feature values may be stored at the same memory address, though at a different depth, and accordingly retrieved using a single memory call (for each time step). In particular, the memory depth may be strictly equal to m, which is sufficient to store data related to every feature at every time step. Yet, having a larger depth may allow additional information (e.g., metadata, parameters) to be stored, if necessary.

In that respect, referring to FIG. 7B, the present methods may advantageously maintain and update a data structure 36, which captures the memory bank 35, while the ML model is being run S34. As illustrated in FIG. 7B, this data structure is representable as a matrix, where each column corresponds to a respective time step and each row corresponds to a respective feature of the input sequence.

Thus, values stored in the memory bank can be read by accessing data from this data structure. This is performed by the memory addresses. Yet, this can be done using a mask designed to select the sole relevant row elements, taking the different season lengths of the different features into account. More precisely, the distinct row elements may be selected according to parameters k₁, k₂, . . . , kₘ, (forming together a vector k), where such parameters reflect the distinct season lengths of the timeseries features, as shown in FIG. 7B.

So, in FIG. 7B, each column corresponds to a different time step (horizontal axis), while the vertical axis corresponds to features; each row corresponds to a respective feature and there are m such features. The mask preferably uses boolean indices (e.g., 0s and 1s), whereby relevant matrix values can be selected (e.g., with a simple scalar product) upon reading from the memory bank (e.g., is are used to select the relevant contents of the memory bank, using relevant parameters kᵢ for each row). In FIG. 7B, the 1s correspond to matrix elements in the blackened boxes. At the next time step, every values can be shifted. In other words, different row parameters (different kᵢ) are used for the different rows of the matrix. Using distinct row indices as shown in FIG. 7B makes it possible to read different features within a same vector with different skip length. This, in turn, allows different season lengths to be taken into account, while still benefitting from simple write and read processes.

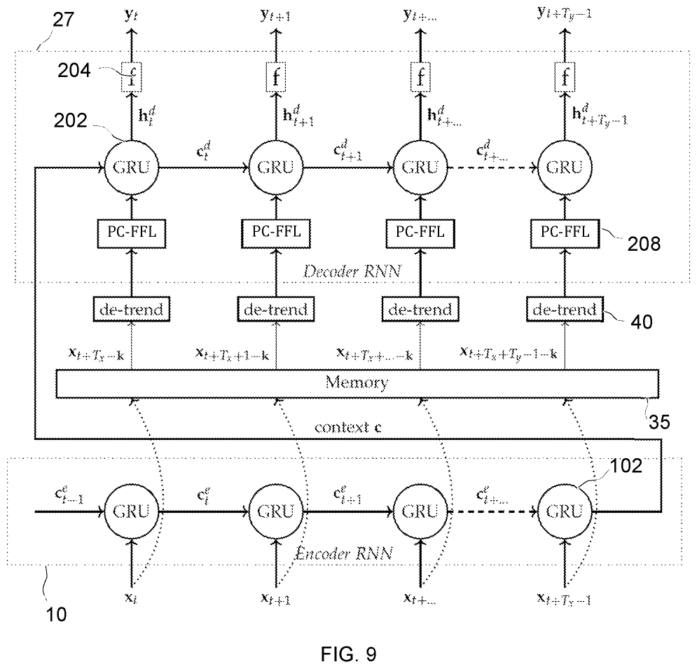

As noted earlier, the architecture shown in FIG. 7A (Skipper v1.0) assumes that the input sequence is used as the feedback sequence. The same approach is used in versions 1.1 and 1.2 of the model, notwithstanding a few modifications, which are discussed below in reference to FIGS. 8 and 9. Note, in each of FIG. 7A and FIG. 9, the forecast series (as obtained in output of the ML model) is identical to the sequence obtained in output of the FC-FFL 204. However, a more sophisticated approach can be contemplated, as discussed now in reference to FIG. 8.

Namely, instead of equating the forecast timeseries to the output sequence, the forecast timeseries may be obtained by adding specific values to the output values obtained in output of the FC-FFL. More precisely, the forecast timeseries may eventually be obtained as weighted contributions from such output values and such specific values. The specific values may notably be values selected from the retrieved (feedback) values, the input values coupled into the encoder RNN, the values outputted from the decoder, or values corresponding to inner layer parameters of the encoder RNN and the decoder RNN.

In the example of FIG. 8, the specific values correspond to values selected from the retrieved values, as assumed in version v1.1 of the model. In this embodiment, a highway connection is enabled between the decoder's input iₜ^{d} and the decoder's output yₜ (e.g., the spatial highway (denoted by dotted arrows) connects the seasonal feedback directly to output units 206). The contributions are preferably weighted according to yₜ=0.5×f(hₜ^{d})+0.5×iₜ^{d}, by the units 206. Using weighted contributions makes it possible to decrease the lowest mean loss and the standard deviation in practice.

Still, instead of the retrieved (feedback) values, one may also use the encoder outputs or the encoder inputs, or hidden states of the RNNs, as noted above. In addition, combinations of such values may be considered for coupling. More generally, various other types of couplings can be contemplated, which may have various end points. The idea is to try and enable any potentially relevant type of connections to allow relevant correlations to be detected.

The timeseries considered herein may include seasonality, trends, and irregularities. Where the timeseries have large seasonality, one may ignore the trends and the irregularities. However, other scenarios may require other approaches. In that respect, another version (v1.2) of the model can be devised, as a step towards including the trend dynamics into the model. As illustrated in FIG. 9, the present methods may additionally comprise de-trending the retrieved values. This can be achieved by differentiation 40, prior to injecting de-trended values in the RNN cells. Moreover, the de-trended values may possibly be further processed through a pre-processing layer 208 consisting of a partly connected feed-forward layer (noted PC-FFL in FIG. 9), prior to injecting the processed values into the cells of the decoder RNN 27. This makes it possible to maintain a reasonably small number of parameters, as also explained in section 2.

If necessary, the present methods may further apply a low-pass filter (LPF) to remove irregularities from the retrieved values, prior to de-trending such values. That is, in such embodiments, an LPF is applied to remove irregularities, then the retrieved values are detrended by differentiation, before being fed to the decoder RNN.

This way, both trend and seasonality components can be accounted for. The long-term trend is included in the feedback. Still, the impact of potential outliers may be mitigated. In other words, such embodiments separate the seasonality and trend components of the seasonal feedback. These embodiments provide a more robust approach to non-stationary timeseries and are particularly well suited to process KPIs with anomaly events.

So, the input sequence may possibly be a non-stationary, multivariate timeseries, where the multivariate timeseries may possibly have various degrees of seasonality. Both the trend and seasonality can be taken into account by the present methods.

For example, in embodiments, the input sequence is a multivariate timeseries, features of which correspond to respective KPIs of a monitored system, such as a complex computerized system (e.g., a server, a datacenter, a supercomputer, cloud storage devices, etc.) where, for example, each KPI is obtained from measured values of a respective quantity related to the operation of this system. That is, KPIs may be computed based on data collected from the computerized system, and according to any suitable metric.

Such KPIs may notably relate to control data, e.g., indicative of traffic state, congestion, etc. For example, KPIs may relate to disk-to-cache transfer rates or, conversely, cache-to-disk transfer rates, using volume cache (VC) or volume copy cache (VCC) metrics for volumes. KPIs may also pertain to data communicated over read and write channels of the system. E.g., streaming KPIs may be used. Between 2 and 800 KPIs may typically be used for the present purposes. Such KPIs may for example be obtained by computing metrics based on values aggregated at step S15 (see FIG. 11). Such values are collected at regular time intervals from the computerized system. An input timeseries can then be formed by aggregating timestamped data.

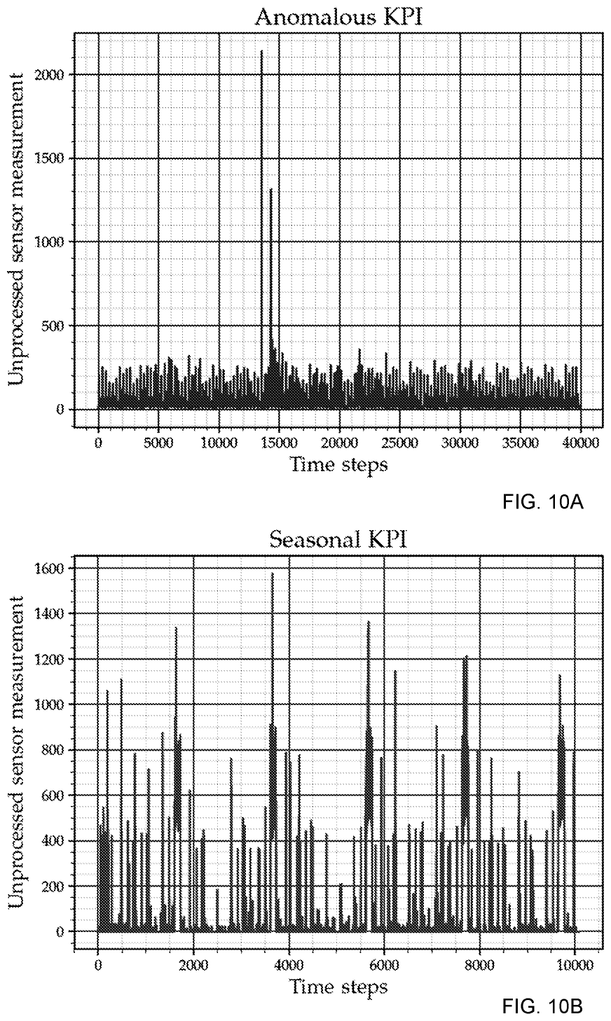

Examples of such KPIs are depicted in FIGS. 10A and 10B. FIG. 10A shows a KPI evolving over a single season. This KPI has a large anomaly at time step≈13,500. The anomaly decays to finally vanish at time step≈17,500. FIG. 10B depicts a KPI over 2016 time steps, corresponding to approximately five seasons. The season length can notably be determined by computing the ACF, as indicated earlier. More generally, a large number of KPIs may be involved in each input sequences (a multivariate timeseries), where each KPI is obtained from measured values of a respective quantity related to the operation of the monitored system.

Another aspect of the invention is now described in reference to FIG. 11, which concerns a method of detection of anomalies in a computerized system. This additional method basically exploits a method as described above in reference to FIGS. 6-9. First, a timeseries is accessed at step S20. The accessed timeseries reflects one or more measured values of time-dependent quantities that pertain to the operation of the computerized system. Next, based on the accessed timeseries, a forecast timeseries is obtained (at step S34) by performing (step S30) a method as described earlier in reference to FIGS. 6-9, where the input sequence corresponds to the timeseries accessed at step S20. A prediction error of the forecast timeseries obtained is subsequently characterized at steps S40-S50. Finally, an anomaly score is determined (step S60) based on the characterized prediction error. This, in turn, allows an anomaly in the computerized system to be potentially detected S70.

The prediction error of the forecast timeseries is preferably characterized by comparing the forecast timeseries with an actual timeseries observed during the same time period. That is, the timeseries accessed at step S20 is a first timeseries, spanning a first time period. Based on this first timeseries, a second timeseries (e.g., the forecast timeseries) is inferred, which spans a second time period up to a given time horizon. Next, the prediction error can be characterized S40-S50 as follows. A third timeseries (e.g., relating to the same quantities as the first and second timeseries) is accessed at step S40. The third timeseries spans the second time period up to the same time horizon as the second timeseries. Thus, the second timeseries can be compared (step S50) with the third timeseries as accessed at step S40. The prediction error can accordingly be characterized according to an outcome of this comparison S40. In variants, cognitive techniques may directly be applied to the forecast timeseries, so as to directly identify anormal features therein.

The above method may typically be performed to monitor a computerized system for anomalies in real time. In that case, the third timeseries may for example be accessed S40 upon reaching the time horizon. The second timeseries is then compared, step S50, with the third timeseries accessed, upon accessing the latter.

This approach exploits properties of statistical predictions to characterize potential anomalies in the monitored system. This is preferably achieved by comparing timeseries predictions (e.g., which assume statistically normal, temporal evolutions of data) to actual timeseries (e.g., actual observations). The actual data may potentially show substantial deviations to the predictions, and such deviations may precisely indicate the occurrence of anomalies in the monitored system.

Anomalies may arise due to malicious actions, frauds, or system failures, for example. Anomalies may generally relate to data traffic anomaly, such as network attacks (e.g., on the business environment, unauthorized accesses, network intrusions), improper data disclosures or data leakages, system malfunctions, or data and/or resources deletion, etc. Anomaly detection is important in various domains, such as cybersecurity, fraud detection, and healthcare. Formally, anomalies are defined as rare events that are so different from other observations that they raise suspicion concerning the mechanism that generated them. Their nature can be maleficent, like an abnormal heart rate, or benevolent like a sudden increase in the demand of a particular product. In both cases, an early detection is of utmost importance as failing to act upon them can cause significant harm, e.g., late diagnosis of a disease or insufficient storage.

The prediction error may for example be obtained in the form of an anomaly score (e.g., a number or a set of numbers), which may be assessed to detect whether an anomaly occurs (or occurred) in the system. This anomaly detection method is preferably performed in real-time to potentially detect a current anomaly. However, anomaly detection methods may also be performed in respect of past timeseries, to detect past anomalies of the system (e.g., for forensic purposes).

Whenever an anomaly is detected (step S70: Yes) based on the obtained anomaly score, then it may be instructed to take action (step S80) in respect of the computerized system, so as to modify a functioning thereof. Any appropriate decision may be made in the interest of preserving the system and/or its environment. Both the type of action taken and its intensity may depend on the extent of anomaly score obtained. For example, a preemptive action may be taken, to preempt or forestall adverse phenomena. E.g., in case a substantial anomaly is detected, some of the data traffic may be interrupted, re-routed, deleted, or even selected parts of the computerized system may be shut down, as necessary to deal with the anomaly detected. More generally, the actions taken modify the way the system normally functions. Moreover, the results obtained at steps S60 and S70 may be logged (step S90), in case of absence of anomaly detected (S70: No). The process may be continually performed, hence the edge looping back to step S20.

A preferred flow is depicted in FIG. 11. Here, the method starts operating the computerized system at step S10. A first timeseries of KPIs is accessed at step S20. The first time series spans a first time period. Note, data pertaining to the operation of a monitored system are continually aggregated at step S15, to form a timeseries as later accessed at step S20. That is, the timeseries accessed at step S20 is formed based on data that is continually aggregated at step S15 over the first time period. Once all required data has been aggregated, such data is assembled to form the first timeseries. The season lengths of the latter are estimated at step S25, e.g., by computing corresponding ACFs.

Timeseries forecasting is subsequently performed at step S30. That is, a ML model is loaded (step S32) and then run (step S34) to infer (e.g., predict) a second timeseries. The second timeseries spans a second time period extending up to a given time horizon, as per the forecasting performed. Next, a third timeseries is accessed at step S40. The third timeseries relates to actual data (e.g., measured values of the same quantities), and spans the same second time period (e.g., up to the same time horizon mentioned above) as spanned by the inferred timeseries. The second timeseries is compared with the third timeseries at step S50. Based on this comparison, an anomaly score is determined at step S60.

At step S70, the method assesses the anomaly score to identify a potential anomaly in the monitored system. If no anomaly is detected at step S70 (step S70: No), the method may simply log this results at step S90. If, however, an anomaly is detected (step S70: Yes), then the method may report this (step S100) where necessary and take steps (S80) to modify the operation of the system, in view of remedying the anomaly (e.g., by modifying the operation of the system or shutting it down).

Then, another cycle can be started. For example, a new timeseries may be accessed at step S20, based on data that has been aggregated S15 in the meantime, to potentially detect another anomaly, and so on. Note, the timeseries as successively accessed at step S20 may partly overlap.

A final aspect of the invention concerns computer program products. Essentially, such a computer program product includes a computer readable storage medium having program instructions embodied therewith. Such program instructions are executable by processing means 105, such as processors of a computerized unit 101 shown in FIG. 12, to cause the latter to implement steps according to the present methods. Aspects of such computer program products are described in detail in section 3.2.

The above embodiments have been succinctly described in reference to the accompanying drawings and may accommodate a number of variants. Several combinations of the above features may be contemplated. Examples are given in the next section.

### 2. Particularly Preferred Embodiments

This section provides a detailed description of preferred forecasting models that incorporate a seasonal feedback mechanism to improve the prediction of seasonal timeseries. The season's length is determined independently for each feature and can be arbitrarily long. Such models are based on a sequence-to-sequence architecture. Before exploring such models in detail, the background concepts are briefly explained.

### 2.1 Background

The following provides a formal definition of the timeseries forecasting problem and discusses background techniques used to develop the present models.

Problem Formulation. Given a series of timely ordered observations X={x₁, x₂, . . . , x_{T}_{ₓ}}∈ [symbol] ^{m×T}^{ₓ}, where m is the number of observed variables at every instance, the goal is to forecast the series of future observations {x_{T}_{ₓ}₊₁, x_{T}_{ₓ}₊₂, x_{T}_{ₓ}_{+T}_{_{y}}}∈ [symbol] ^{m×T}^{_{y}}. So, the parameters Tₓ and T_{y} correspond to the input's length and the forecasting horizon, respectively. In the following, the compact notation {x₁, x₂, . . . , x_{T}_{ₓ}}=x_{1:T}_{ₓ} is used to ease the exposition.

Timeseries. Formally such a sequence of observations is called a timeseries. A timeseries can be regarded as a composition of several temporal variations. Three types of variations can be identified: the long-term tendency or trend T; the periodic or seasonal variation S; and the residual component or irregularities I.

The overall timeseries is typically an additive or multiplicative combination of these terms, see equations 2.1 and 2.2 of Kouziou 2020, respectively. Note, all equations mentioned herein refer to equations of Kouziou 2020. Equation 2.1 can be used where all three terms are independent, while equation 2.2 can be used in other cases.

Because the trend and seasonality components affect X differently at each time step, X is not time-independent, so it is non-stationary.

Autocorrelation Function. An important function in the area of timeseries analysis is the autocorrelation, which is a similarity measure between a univariate timeseries X and a time-shifted (e.g., delayed) version of itself. In mathematical terms, the ACF of X is given by equation 2.3 of Kouziou 2020 (e.g., R(l)=Σₜ₌₀^{T}^{ₓ}⁻¹xₜxₜ₊ₗ, where R is the ACF value, l is the delay or lag for which we calculate the ACF and Tₓ is the total duration of X).

From equation 2.3 it can be proved that R peaks when the two timeseries are in phase with each other, which happens once every season. We can therefore use the ACF value as an indicator of how seasonal a timeseries is for a particular lag. If the ACF is not large for any lag, then we can conclude that the timeseries is not seasonal, otherwise, we can get the duration of the season from the lag producing the ACF peak.

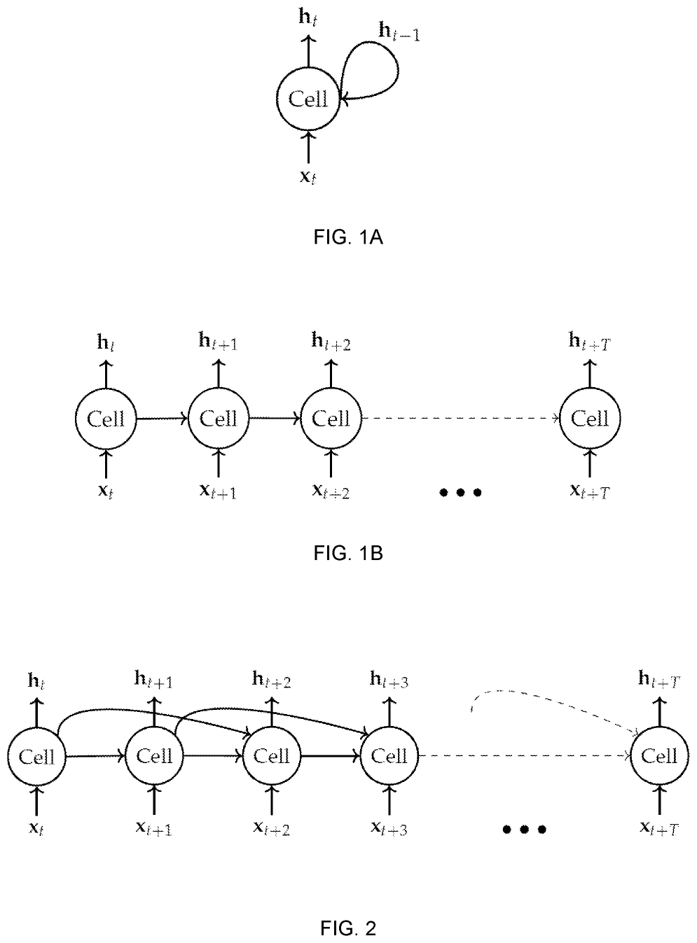

Unlike other ML networks that are state-free, RNNs incorporate feedback connections to build a dynamic state. This acts as a short-term memory so that the RNN output at time t depends not only on the current input xₜ but also on xₜ₋₁, xₜ₋₂, etc. Formally the RNN output hₜ, for, e.g., a Vanilla RNN cell, is defined as in Eq. 2.4 of Kouziou 2020, i.e., hₜ=tanh(b+W^{x}xₜ+W^{h}hₜ₋₁), where hₜ denotes both the cell's output and the RNN state, W^{x} and W^{h} are the weights associated with the input x and the state h respectively, and b is a bias. All such parameters are time-independent parameters. That is, features are equally learned independently of their position in the sequence. This further allows the network to generalize to sequences with a length that differs from the lengths seen during the training.

Where such benefits are not required for a particular application, the network's capacity can be increased by using different parameters at each time step. FIGS. 1A and 1B depicts both the recurrent form of an RNN and its unfolded form in time representation.

Sequence limits of RNNs. Observing equation 2.4 and FIG. 1B that is another representation of FIG. 1A, we can deduct that there is a computational path connecting h_{τ+t} to x_{τ}. Mathematically, we can show that for an RNN without the tanh activation function, the equation connecting x_{τ} with h_{τ+t} is given by Eq. 2.5 of Kouziou 2020, i.e., h_{τ+t}=(W^{h})^{t}W^{x}x_{τ}. Then, if W^{h} has an eigendecomposition of the form W^{h}=QΛQ^{T} with orthogonal Q, then equation 2.5 becomes h_{τ+t}=QΛ^{t}Q^{T}W^{x}x_{τ}. Therefore, as t increases, any eigenvalues that are not exactly 1 will either decay to 0 (if they are less than 1) or explode (if they are larger than 1). The former scenario will cause the RNN to forget any component of x_{τ} that was associated with that eigenvalue, while the latter will make the training unstable. Therefore, Vanilla RNNs will most likely fail when trained with sequences longer than 10 to 20 time steps. The same issues are encountered during the backward pass of the backpropagation algorithm, causing the gradients to either vanish or explode; such problems are referred to as the vanishing and exploding gradients problems.

More sophisticated cells and architectures have been proposed to mitigate such problems.

LSTMs. The LSTM was the first RNN cell to demonstrate superior performance in learning sequences with long dependencies. This is achieved using a memory state, called the Constant Error Carousel (CEC), and three gate mechanisms that control the information flow into and out of this state. This way, the gradients are much better regulated, decreasing the chances of them vanishing or exploding. The LSTM cell update functions are presented in equations 2.7-2.12 of Kouziou 2020, where f, i, and o are the forget, input and output gate mechanisms respectively and c is the CEC, which is also referred to as the carry state.

GRU. The GRU can be considered as a simplified variant of the LSTM cell without an output gate. Its reset gate regulates the information passing from the previous state to a newly proposed one and that is combined with the input to produce the GRU output. Essentially, the GRU has combined the LSTM input and forget gates into a single update gate. The GRU update mechanism is shown algebraically in equations 2.13-2.16 and graphically in FIGS. 2.3 of Kouziou 2020. In principle, other types of cells may be contemplated in RNNs.

Skip Connections. Another way to deal with long-term dependencies is to use bypass or temporal skip connections between the states of distant RNN cells. Such an approach allows the vanishing gradient problem to be alleviated. An RNN with skip connections is shown in FIG. 2. Skip connections may connect the states of distant RNN cells just as the cells' inputs or outputs.

Sequence-to-sequence architectures. So far, we have discussed RNNs that produce an output instance hₜ for every input xₜ. This structure is optimal only if the following two assumptions are satisfied: (i) there is an alignment between the input and output instances, meaning that hₜ is independent of x_{τ}, ∀_{τ}>t; and (ii) the length of the input sequence Tₓ equals the length of the output sequence T_{y}.

However, such assumptions do not always hold. For example, consider the task of machine translation. A sentence of r words in English will mostly not translate into a sentence of exactly r words in Greek. Also, they will usually not have the same alignment. In these cases, we can use a combination of two RNNs in a sequence-to-sequence or encoder decoder architecture.

The network then uses the first RNN to map an input sequence X into a fixed dimensionality vector c, which is then decoded by the second RNN to produce an output sequence H=h_{t:t+T}_{_{y}}₋₁^{d}. Note, the superscript d is used to denote that the vector h belongs to the decoder RNN. The vector c is here referred to as the context.

In this architecture, hₜ^{d} is produced only after the network has observed the complete input sequence and therefore the alignment assumption is no longer required. Moreover, T_{y} is independent of Tₓ. FIG. 3 shows such an architecture for a common case, where c is the last state of the encoder RNN and is used to initialize the state of the decoder RNN.

We can apply this architecture to the general problem as formulated above.

Neural Turing Machines. As noted earlier, RNNs differ from other neural networks in that they possess a dynamic state that acts as short-term memory, the capacity of which remains bounded. Neural Turing Machines (NTMs) bypass this problem by coupling RNNs with an additional memory component M.

To ensure the architecture is differentiable, instead of addressing individual memory elements, the network uses write and read operations, such as, heads that interact to some degree with the whole memory. The degree of this interaction is controlled by an attentional mechanism, emitted separately by each head. However, the memory is not addressable in the sense understood herein. For example, data stored in the memory cannot be deterministically (e.g., controllably and systematically) recalled by the algorithm.

Writing. Let Mₜ be the contents of the N×R memory matrix M at time t, where N is the number of locations, and R is the vector size at each location. Then, at each time step, the memory can be updated as shown in Eqs. 2.20 and 2.21 of Kouziou 2020.

Reading. Information can be retrieved from the memory according to Eq. 2.22. Key quantities are wₜ^{write}, wₜ^{read}, aₜ, and eₜ. The quantities w and et, are all weight vectors emitted by the write head at time t, with dimensions N×1, 1×R, and 1×R, respectively. The quantity wₜ^{write} determines the memory locations that will be accessed, eₜ regulates the information from the previous time step that will remain in the accessed memory locations, and aₜ contains the information that the network wants to add to the memory. All elements of wₜ^{write} and eₜ lie in the ranges [0, 1] and (0, 1), respectively wₜ^{read} is a normalized weight vector with dimensions N×1, emitted by the read head at time t.

Addressing Mechanisms. At each time step, the network emits weights wₜ^{write} and wₜ^{write}, according to a location- and a content-based addressing mechanism. Their combination gives rise to three complementary modes of operation, see sect. 2.5.3 of Kouziou 2020.

### 2.2 Particularly Preferred Embodiments

The present approaches are inspired by temporal skip connections and Neural Turing Machines, with substantial differences. In particular, an efficient addressing scheme is relied on, in order to improve a sequence-to-sequence baseline for forecasting timeseries with long seasons. We first discuss the baseline architecture along with an initial approach to improving it. Several variants of the model are then discussed in detail.

Baseline model. We built a baseline forecasting model based on the sequence-to-sequence architecture. As explained earlier, it uses an encoder RNN to map an input sequence X=x_{t:t+T}_{ₓ}₋₁ to a fixed dimensionality vector c that is then decoded by a decoder RNN to produce a sequence H=h_{t:t+T}_{_{y}}₋₁^{d}. We further augment the decoder RNN with a fully connected Feed-forward layer so that the dimensionality of the output sequence Y=y_{t:t+T}_{_{y}}₋₁=\hat{x}_{t+T}_{ₓ}_{:t+T}_{_{y}}₋₁ is decoupled from the dimensionality of H. Mathematically, this is described by equation 3.1 of Kouziou 2020, i.e., yₜ=f(hₜ^{d})=W^{f}hₜ^{d}+b^{f}, where W^{f} is a weight matrix and b^{f} is a bias. Again, Tₓ and T_{y} are the input's length and the forecasting horizon, respectively, it being noted that the forecasting accuracy may benefit from using Tₓ>>T_{y}.

We have tested RNNs based on LSTM and GRU cells, leading essentially to similar results. However, use is preferably made of GRU cells because their smaller number of gates implies less training parameters. As a result, they happen to converge faster and are computationally more tractable. The overall baseline architecture is depicted in FIG. 4.

Initial Approach—Skipper v0 (not according to embodiments). We use temporal skip connections to increase the effective memory of the RNNs in our baseline model so that they can capture longer dynamics. We set the skip length, k, equal with the timeseries season length so that the gradients connecting the same instances of two subsequent seasons do not decay (the gradient's vanishing rate between shifted instances tends to k/k=1). For each timeseries we find k off-line, using the ACF. The skip length k then corresponds to the ACF lag with the highest ACF value. Here, we assume either a univariate timeseries or that all its features have the same season length.

We are interested in capturing arbitrarily long seasonal dynamics. However, temporal skip connections cannot exist for k>>Tₓ, as these would exceed the number of unfolded cells. To solve this issue, we augment both the encoder RNN and the decoder RNN with an external memory bank that is used to store the GRU state at every time step and retrieve it k time steps later.

Unlike the vanilla NTMs, however, we do not require the network to optimize the information that is written to and read from the memory at every time step. Therefore, the model parameters do not have to be trainable. This leads to modified write and read operations. In addition, in this implementation, the depth, R, of each memory location, equals the number of the GRU units, see Sect. 3.2 of Kouziou 2020.

The overall architecture is depicted in FIG. 5. As interesting as it may be, this approach has drawbacks in terms of training. In particular, because we train with each input sequence belonging to a different batch, gradients flowing through the skip connection may not vanish. Instead, they are erased as they cannot be backpropagated to previous batches. Nonetheless, because the instances connected by the skip connection are highly correlated, we hypothesized that even the forward pass of cₜ₋ₖ to the GRU at time t could have benefits. Unfortunately, we observed that as a result of the GRU parameters changing after every batch, the information encoded in cₜ₋ₖ could not be decoded by the GRU parameters at time t. Therefore, this architecture is not tractable for long seasons.

First improvement: Skipper v0.1. However, it can be realized that there is a way to map the cₜ₋ₖ created by the GRU parameters at time t−k to a skip state equivalent, produced by the GRU parameters at time t, as discussed in sect. 3.2.1 of Kouziou 2020. Eventually, the skip state is evaluated according to equation 3.9, i.e., skip state=f⁻¹(yₜ₋ₖ), where f is the linear function of the Feed-forward layer described by equation 3.1.

Although promising, this approach requires the frequent inversion of a matrix, which can potentially be very large and thus computationally expensive in some applications. This approach is depicted in FIG. 6.

Further improvement: Skipper v1.0. The model Skipper v0 is limited to using the same seasonal feedback (the skip state) for all timeseries features. This is sub-optimal for multivariate timeseries whose features have seasons of different lengths.

We define the vector k=(k₁, . . . , kₘ) so that kᵢ is the season's length of the i^{th} feature of the timeseries and xₜ₋ₖ=(xₜ₋ₖ_{₁}¹, . . . , xₜ₋ₖ_{ₘ}^{m}). Then, we take advantage of the alignment between xₜ₋ₖ and xₜ, emerging from their autocorrelation, and use xₜ₋ₖ as an input to the decoder RNN, at the instance it produces \hat{x}ₜ. So, because yₜ=\hat{x}_{t+T}_{ₓ} the decoder input at time t is iₜ^{d}=x_{t+T}_{ₓ}₋ₖ.

To accommodate this architectural change, we may alter the memory's depth at each location from R=state size to R=m. We further change the dimensions of wₜ^{read} from N×1 to N×m, see FIG. 7B, and adapt its initialization so that it is zero everywhere apart from wₜ₌₀^{read}[i, Tₓ−kᵢ]=1. Last but not least, since x is the beginning of the computational path, there is no need to ensure that the mechanism that generates it is differentiable. We, therefore, simplify the addressing mechanism using wₜ^{write} and wₜ^{read} as boolean indexes. The memory read and write operations are given by Eqs. 3.10 and 3.11 of Kouziou 2020, namely rₜ[i]←Mₜ[wₜ^{read}[i]] and Mₜ[wₜ^{write}]←aₜ, where aₜ=xₜ and rₜ=x_{t+T}_{ₓ}₋ₖ.

Advantages of Skipper v1.0. Skipper v1.0 uses a long-term seasonal feedback that is uncoupled from the timeseries short-term dynamics. The update gate of the GRU cell regulates how these dynamics are combined to produce the decoder RNN output. If the seasonal feedback is not useful the GRU can completely ignore it by driving the corresponding weight matrix elements to zero. On the other hand, if the input sequence is completely periodic, then the GRU can completely ignore the context vector and the previous state by driving the corresponding weight matrix elements to zero and create a unity connection between the seasonal feedback and the output.

Unlike the initial approach, this variant allows each feature of the timeseries to have a different skip length. This is accomplished by using a different row index for each row of the memory matrix, see equation 3.10, see sect. 3.3.1 of Kouziou 2020

Memory Requirements. In addition to the requirements set by the baseline, Skipper v1.0 also requires an N×m float matrix, an N×m boolean matrix, and an N×1 boolean vector. If a float is represented by 32 bits and a boolean by 1 bit, then these additional requirements are N×m×32+N×m+N bits=N×(33×m+1) bits. Moreover, if we set N=2×max(k) then Skipper's memory cost is only 2×max(k)×(33×m+1), which is linear to both max(k) and m. Skipper v1.0 is depicted in FIG. 7A.

Skipper v1.1. Most DL optimization algorithms, including many regularization techniques, will favor parameters with small values versus larger ones. However, the present approach was developed based on the assumption that xₜ₋ₖ is highly similar to xₜ and therefore we expect the weights connecting yₜ and iₜ^{d} not to have small values.

Instead of looking for optimal optimization algorithms, which may or may not be equally suitable for the model, we propose a further variant, Skipper v1.1, which uses a highway connection between the decoder's output yₜ and the decoder's input iₜ^{d} as suggested in FIG. 8. This causes a portion of the input to be directly forwarded to the output without going through the network's weights. Empirically, we may set yₜ=0.5×f(hₜ^{d})+0.5×iₜ^{d}, see Eq. 3.12 of Kouziou 2020.

In the cases where this is not well suited, the network can still adjust h^{d}ₜ so that it cancels a part of i^{d}ₜ.

Skipper v1.2. As indicated earlier, a timeseries can be composed of a seasonality, a trend, and an irregularities component. Where timeseries have a large seasonality, we can ignore both the trend and the irregularities, as done above. Another variant of the model (Skipper v1.2) can be devised, as a step towards including the trend dynamics into the model.

Namely, we may consider the case of additive composition, whereby X=T+S+I, according to equation 2.1. Under the reasonable assumption that the timeseries is predictable, we can deduct that the irregularities component has to be quite small and, therefore, we can neglect it. In that case, X=T+S.

To separate the two components of the last equation, we can apply de-trending by differentiation, see Eqs. 3.14 to 3.17 of Kouziou 2020. The resulting equations can be used in the seasonal feedback x_{t+T}_{ₓ}₋ₖ to obtain the corresponding season and trend components. These can now be fed as separate features into the decoder RNN but then the number of parameters of the resulting model will significantly increase. Thus, we may advantageously use a pre-processing layer according to equation 3.18 of Kouziou 2020, which corresponds to a partly connected Feed-forward layer. We show this architecture in FIG. 9.

### 2.3 Results

The performance in forecasting of the present models were evaluated using two multivariate seasonal timeseries of metrics created by unprocessed sensor measurements. The goal was to show that the present models (v1.0 to v1.2) outperform the baseline by learning long seasonal dynamics that cannot easily be captured by the GRU cell. To prove that, we used the same number of layers, recurrent units, and optimization algorithm for all the compared models. The timeseries reflect KPIs that describe the device's read/write rates, sizes of transferred data, etc., as calculated using readings from multiple installed sensors. Because these readings are often directly associated with customers' workloads, such metrics are thought to have daily or weekly seasonality. Thus, the models proposed herein are believed to be useful to predict future workloads that can help guarantee an optimal operation of the devices.

Such KPIs correspond to devices sampled every 5 minutes. Therefore, the aforementioned seasonalities correspond to 288 and 2016 time steps respectively. This was confirmed by computing respective ACFs.

The results obtained show that Skipper v1.0 improves upon the baseline both in terms of convergence rate and final loss. Since the only difference between these two models is the seasonal feedback, we can be certain that this is the only cause of the improvement. Concerning Skipper v1.1 and Skipper v1.2 we have demonstrated that, depending on the existence of anomalies, they can both complementary outperform the baseline. Thus, in all cases, incorporating seasonal feedback in the decoder RNN proves to be beneficial. In particular, the inventors have concluded that the present models have an effectively larger memory than the Vanilla sequence-to-sequence architecture.

The present models have proved to be robust forecasting models, even under the presence of anomalies. The performance of such models has been assessed within an anomaly detection (AD) pipeline, where an anomaly is identified based on the distance between a model's prediction and the true values of the timeseries, as explained in section 1. Such models successfully leverage a timeseries' seasonality to increase the accuracy of its predictions. This offers significant gains both for the prediction task itself and for determining potential anomalies.

The main limitation of the above models is in the off-line dependence on the ACF computation. Still, a temporal attention mechanism may possibly be used to address this issue by adjusting the skip length k within a small time window. If this window is small enough the computational cost associated with the temporal attention mechanism will be minimum.

### 3. Technical Implementation Details

### 3.2 Computerized Systems and Devices

Computerized systems and devices can be suitably designed for implementing embodiments of the present invention as described herein. In that respect, it can be appreciated that the methods described herein are largely non-interactive and automated. In exemplary embodiments, the methods described herein can be implemented either in an interactive, a partly interactive, or a non-interactive system. The methods described herein can be implemented in software, hardware, or a combination thereof. In exemplary embodiments, the methods proposed herein are implemented in software, as an executable program, the latter executed by suitable digital processing devices. More generally, embodiments of the present invention can be implemented wherein virtual machines and/or general-purpose digital computers, such as personal computers, workstations, etc., are used.

For instance, FIG. 12 schematically represents a computerized unit 101 (e.g., a general- or specific-purpose computer), which may possibly interact with other, similar units 101, to be able to perform steps according to the present methods.

In exemplary embodiments, in terms of hardware architecture, as shown in FIG. 12, each unit 101 includes at least one processor 105, and memory 110 coupled to a memory controller 115. Several processors (CPUs, and/or GPUs) may possibly be involved in each unit 101. To that aim, each CPU/GPU may be assigned a respective memory controller, as known per se.

One or more input and/or output (I/O) devices 145, 150, 155 (or peripherals) are communicatively coupled via a local input/output controller 135. The input/output controller 135 can be coupled to or include one or more buses and a system bus 140, as known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processors 105 are hardware devices for executing software instructions. The processors 105 can be any custom made or commercially available processor(s). In general, they may involve any type of semiconductor-based microprocessor (in the form of a microchip or chip set), or generally any device for executing software instructions.

The memory 110 typically includes volatile memory elements (e.g., random-access memory), and may further include nonvolatile memory elements. Moreover, the memory 110 may incorporate electronic, magnetic, optical, and/or other types of storage media. External (e.g., secondary or auxiliary) storage 120 is normally available, which is not directly accessible by the processing means 105, as usual.

Software in memory 110 may include one or more separate programs, each of which includes executable instructions for implementing logical functions. In the example of FIG. 12, instructions loaded in the memory 110 may include instructions arising from the execution of the computerized methods described herein in accordance with exemplary embodiments. The memory 110 may further load a suitable operating system (OS). The OS essentially controls the execution of other computer programs or instructions and provides scheduling, input-output control, file and data management, memory management, and communication control and related services.

Possibly, a conventional keyboard and mouse can be coupled to the input/output controller 135. Other I/O devices 145, 150, 155 may be included. The computerized unit 101 can further include a display controller 125 coupled to a display 130. Any computerized unit 101 will typically include a network interface or transceiver 160 for coupling to a network, to enable, in turn, data communication to/from other, external components, e.g., other units 101.

The network transmits and receives data between a given unit 101 and other devices 101. The network may possibly be implemented in a wireless fashion, e.g., using wireless protocols and technologies, such as Wifi, WiMax, etc. The network may notably be a fixed wireless network, a wireless local area network (LAN), a wireless wide area network (WAN), a personal area network (PAN), a virtual private network (VPN), an intranet or other suitable network system and includes equipment for receiving and transmitting signals. Preferably though, this network should allow very fast message passing between the units.

The network can also be an IP-based network for communication between any given unit 101 and any external unit, via a broadband connection. In exemplary embodiments, network can be a managed IP network administered by a service provider. Besides, the network can be a packet-switched network such as a LAN, WAN, Internet network, an Internet of things network, etc.

### 3.2 Cloud and Abstraction Layer Implementation

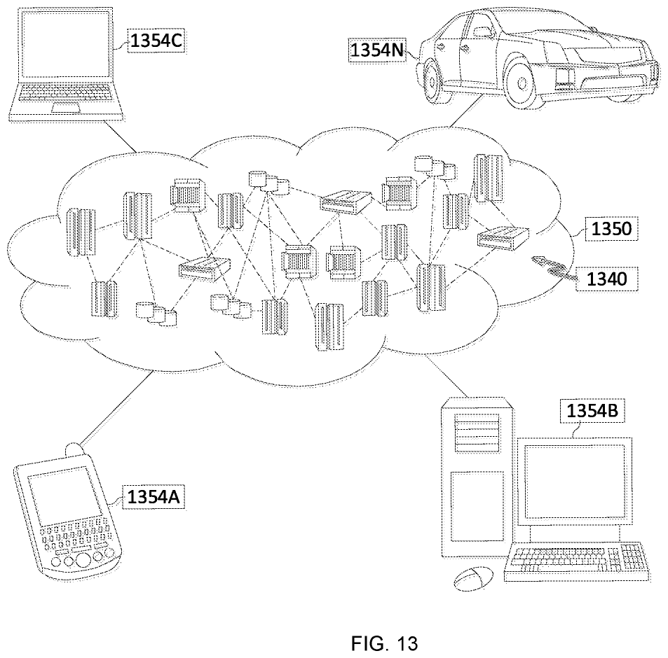

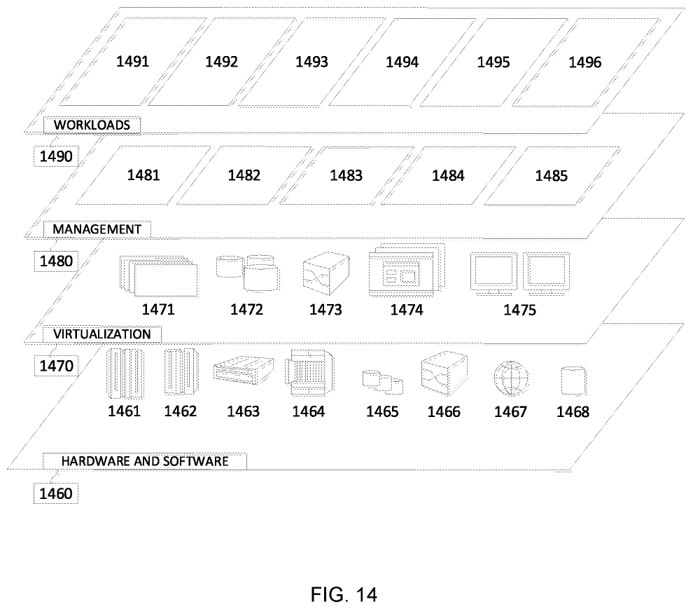

Referring now to FIG. 13, illustrative cloud computing environment 1350 is depicted. As shown, cloud computing environment 1350 includes one or more cloud computing nodes 1340 with which local computing devices used by cloud consumers, such as, for example, personal digital assistant (PDA) or cellular telephone 1354A, desktop computer 1354B, laptop computer 1354C, and/or automobile computer system 1354N may communicate. Nodes 1340 may communicate with one another. They may be grouped (not shown) physically or virtually, in one or more networks, such as Private, Community, Public, or Hybrid clouds as described hereinabove, or a combination thereof. This allows cloud computing environment 1350 to offer infrastructure, platforms and/or software as services for which a cloud consumer does not need to maintain resources on a local computing device. It is understood that the types of computing devices 1354A-N shown in FIG. 13 are intended to be illustrative only and that computing nodes 1340 and cloud computing environment 1350 can communicate with any type of computerized device over any type of network and/or network addressable connection (e.g., using a web browser).

Referring now to FIG. 14, a set of functional abstraction layers provided by cloud computing environment 50 (FIG. 13) is shown. It should be understood in advance that the components, layers, and functions shown in FIG. 14 are intended to be illustrative only and the exemplary embodiments are not limited thereto. As depicted, the following layers and corresponding functions are provided:

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and queue processing 96.

### 3.3 Computer Program Products

The present invention may be a method and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

### List of Abbreviations Used

ACF Autocorrelation function

AD Anomaly detection

CEC Constant error carousel

DL Deep learning

FC-FFL Fully connected feed-forward layer

GRU Gated recurrent unit

KPI Key performance indicator

LSTM Long-short term memory

ML Machine learning

MSE Mean squared error

NTM Neural Turing machine

PC-FFL Partly connected feed-forward layer

RNN Recurrent neural network

SME Subject matter expert

What is claimed is:

1. A computer-implemented method of forecasting a timeseries, the method comprising:
loading a machine learning model that includes
two recurrent neural networks, or RNNs, including an encoder RNN coupled to a decoder RNN, the machine learning model designed to allow the encoder RNN to map an input sequence X into a fixed-dimensionality vector c and the decoder RNN to decode such a vector c to produce an intermediate sequence H, and
a fully connected feed-forward layer, or FC-FFL, which is coupled to the decoder RNN to be able to produce, from the intermediate sequence H, an output sequence Y having a dimensionality that is decoupled from a dimensionality of the intermediate sequence H; and
running the machine learning model by concomitantly
coupling values of a given input sequence forming a timeseries into the encoder RNN to produce a given output sequence in output of the FC-FFL and obtain a forecast timeseries based on the given output sequence,
storing values of a feedback sequence in a location-addressable memory bank connected to the loaded model, the feedback sequence being one of the given input sequence and the given output sequence, wherein memory addresses of the memory bank are mapped onto a temporal sequence of the feedback sequence, whereby time-shifted values of the feedback sequence are stored at respective memory addresses of the memory bank, and
reading values stored in the memory bank by said memory addresses to retrieve values of the feedback sequence and feeding the retrieved values to the decoder RNN.

2. The method according to claim 1, wherein
the feedback sequence is the given input sequence and the retrieved values are injected in respective cells of the decoder RNN, so as to achieve temporal skip connections between cells of the decoder RNN.

3. The method according to claim 2, wherein
the feedback sequence is the given output sequence.

4. The method according to claim 2, wherein
the method further comprises estimating a season length of timeseries features of the input sequence, prior to running the machine learning model; and
reading the values stored in the memory bank further comprises using the estimated season length to retrieve values of the feedback sequence that pertain to a season preceding a given season, to which values of the forecast timeseries obtained pertain.

5. The method according to claim 4, wherein
said season lengths are estimated by computing an autocorrelation function of the corresponding timeseries features.

6. The method according to claim 4, wherein
a memory depth R at each memory location corresponding to a respective one of said memory addresses is larger than or equal to a number m of timeseries features of the feedback sequence.

7. The method according to claim 6, wherein the method further comprises,
while running the machine learning model, maintaining a data structure capturing said memory bank, the data structure being representable as a matrix comprising rows and columns, wherein each of the columns corresponds to a respective time step and each of the rows corresponds to a respective feature of said given input sequence, and
the values stored in the memory bank are read by accessing data from said data structure, on a per row basis, by said memory addresses, using a mask designed so as to select distinct row elements of the rows of the data structure, wherein the distinct row elements are selected according to distinct season lengths of the timeseries features.

8. The method according to claim 4, wherein the method further comprises
adding specific values to output values obtained in output of the FC-FFL, so as to obtain said forecast timeseries as weighted contributions from said output values and said specific values, wherein said specific values are values selected from one of:
the retrieved values;
the values coupled into the encoder RNN;
values outputted by the decoder; and
values corresponding to inner layer parameters of one or each of:
the encoder RNN; and
the decoder RNN.

9. The method according to claim 8, wherein
said specific values correspond to values selected from the retrieved values.

10. The method according to claim 4, wherein the method further comprises
de-trending the retrieved values by differentiation, prior to injecting the de-trended values in the RNN cells.

11. The method according to claim 10, wherein the method further comprises
processing the detrended values through a pre-processing layer consisting of a partly connected feed-forward layer, prior to injecting the processed values into the cells of the decoder RNN.

12. The method according to claim 10, wherein
the method further comprises applying a low-pass filter to remove irregularities from the retrieved values, prior to de-trending such values.

13. The method according to claim 1, wherein
the given input sequence is a non-stationary, multivariate timeseries.

14. The method according to claim 1, wherein
the given input sequence is a multivariate timeseries, and
features of the timeseries correspond to respective key performance indicators of a computerized system.

15. The method according to claim 1, wherein
cells of each of the encoder RNN and the decoder RNN are gated recurrent units.

16. A computer-implemented method of detecting an anomaly in a computerized system, wherein the method comprises:
accessing a timeseries of one or more measured values of quantities pertaining to the operation of the computerized system;
based on the accessed timeseries, obtaining a forecast timeseries by performing the method according to claim 1, wherein said given input sequence corresponds to the accessed timeseries;
characterizing a prediction error of the forecast timeseries obtained; and
based on the characterized prediction error, determining an anomaly score to potentially detect an anomaly in the computerized system.

17. The method according to claim 16, wherein
the timeseries accessed is a first timeseries spanning a first time period;
the forecast timeseries is a second timeseries spanning a second time period up to a given time horizon; and
characterizing the prediction error comprises:
accessing a third timeseries of said quantities, the third timeseries spanning the second time period up to said time horizon; and
comparing the second timeseries inferred with the third timeseries accessed.

18. The method according to claim 17, wherein
the method is performed so as to monitor the computerized system for anomalies in real time, whereby the third timeseries is accessed upon reaching said time horizon and the second timeseries is compared with the third timeseries accessed upon accessing said third timeseries.

19. The method according to claim 17, wherein
the method further comprises instructing to take action in respect of the computerized system, if an anomaly is detected based on the obtained anomaly score, so as to modify a functioning of the computerized system.

20. A computer program product for forecasting a timeseries, the computer program product comprising a computer readable storage medium having program instructions embodied therewith, the program instructions executable by processing means, so as to cause the processing means to:
load a machine learning model that includes
two recurrent neural networks, or RNNs, including an encoder RNN coupled to a decoder RNN, the machine learning model designed to allow the encoder RNN to map an input sequence X into a fixed-dimensionality vector c and the decoder RNN to decode such a vector c to produce an intermediate sequence H, and
a fully connected feed-forward layer, or FC-FFL, which is coupled to the decoder RNN to be able to produce, from the intermediate sequence H, an output sequence Y having a dimensionality that is decoupled from a dimensionality of the intermediate sequence H; and
run the machine learning model by concomitantly
coupling values of a given input sequence forming a timeseries into the encoder RNN to produce a given output sequence in output of the FC-FFL and obtain a forecast timeseries based on the given output sequence,
storing values of a feedback sequence in a location-addressable memory bank connected to the loaded model, the feedback sequence being one of the given input sequence and the given output sequence, wherein memory addresses of the memory bank are mapped onto a temporal sequence of the feedback sequence, whereby time-shifted values of the feedback sequence are stored at respective memory addresses of the memory bank, and
reading values stored in the memory bank by said memory addresses to retrieve values of the feedback sequence and feeding the retrieved values to the decoder RNN.
